(19) United States
(12) Patent Application Publication
(10) Pub. No.: US 2026/0302838 A1
(43) Pub. Date: Oct. 1, 2026

(54) WIRELESS POWER SUPPLY SYSTEM

(71) Applicant: TOYODA GOSEI CO., LTD., Kiyosu-shi (JP)

(72) Inventors: Tomokazu SAKAI, Kiyosu-shi (JP); Teppei ABE, Kiyosu-shi (JP); Atsushi SUGIHARA, Kiyosu-shi (JP)

(21) Appl. No.: 19/551,358

(22) Filed: Feb. 26, 2026

(30) Foreign Application Priority Data
Mar. 26, 2025 (JP) 2025-051907

(51) Int. Cl. H02J 50/80; H02J 50/20; H02J 50/40

(52) U.S. Cl. CPC H02J 50/80; H02J 50/20; H02J 50/40

(57) ABSTRACT

A wireless power supply system includes a power receiving device including a power reception control unit that has power reception-side authentication information and controls a power receiving-communication antenna unit based on a monitoring result of a monitoring unit to transmit an intensity signal related to the intensity of received power, and a power transmitting device including a power transmitting antenna unit that transmits a power transfer signal, a phase unit that adjusts a phase of the power transfer signal, a power transmitting-communication antenna unit that receives the intensity signal, and a power transmission control unit that has power transmission-side authentication information and controls the phase unit to perform phase control of the power transfer signal for the power receiving device for which authentication using the power reception-side authentication information and the power transmission-side authentication information has been successful.

### CROSS-REFERENCE TO RELATED APPLICATIONS

The present patent application claims the priority of Japanese patent application No. 2025/051907 filed on March 26, 2025, and the entire contents of Japanese patent application No. 2025/051907 are hereby incorporated by reference.

### Technical Field

The present invention relates to a wireless power supply system.

### Background Art

A power transmitting device is known which, when plural power receiving devices are detected, gives a priority to a registered power receiving device among the plural power receiving devices and selects it as a power transmission destination (see, e.g., Patent Literature 1).

The power transmission device acquires the battery status from a power receiving device, and when the battery status is less than 50%, power is transmitted even when the power receiving device is not registered.

### Citation List

### Patent Literature

Patent Literature 1: JP 2015/111985A

### SUMMARY OF INVENTION

The power transmitting device transmits power to even unregistered devices depending on the battery status and thus has a problem of consuming unnecessary power, causing a decrease in power transmission efficiency.

It is an object of the invention to provide a wireless power supply system capable of improving power transmission efficiency.

One aspect of the invention provides a wireless power supply system, comprising:

a power receiving device comprising a power receiving antenna unit that receives a power transfer signal, a rectifier unit that rectifies the power transfer signal into received power, a monitoring unit that monitors an intensity of the received power, a power receiving-communication antenna unit that transmits an intensity signal related to the intensity of the received power, and a power reception control unit that has power reception-side authentication information and controls the power receiving-communication antenna unit based on a monitoring result of the monitoring unit to transmit the intensity signal; and

a power transmitting device comprising a power transmitting antenna unit that transmits the power transfer signal, a phase unit that adjusts a phase of the power transfer signal, a power transmitting-communication antenna unit that receives the intensity signal, and a power transmission control unit that has power transmission-side authentication information and controls the phase unit to perform phase control of the power transfer signal for the power receiving device for which authentication using the power reception-side authentication information and the power transmission-side authentication information has been successful.

### Advantageous Effects of Invention

According to an embodiment of the invention, it is possible to improve power transmission efficiency.

### BRIEF DESCRIPTION OF DRAWINGS

FIG. 1 is a diagram illustrating an example of a wireless power supply system in an embodiment.

FIG. 2 is an example block diagram illustrating the wireless power supply system in the embodiment.

FIG. 3 is a sequence diagram illustrating an example operation of the wireless power supply system in the embodiment.

### DESCRIPTION OF EMBODIMENT

### Summary of the embodiment

The wireless power supply system in the embodiment is generally composed of a power receiving device comprising a power receiving antenna unit that receives a power transfer signal, a rectifier unit that rectifies the power transfer signal into received power, a monitoring unit that monitors an intensity of the received power, a power receiving-communication antenna unit that transmits an intensity signal related to the intensity of the received power, and a power reception control unit that has power reception-side authentication information and controls the power receiving-communication antenna unit based on a monitoring result of the monitoring unit to transmit the intensity signal; and a power transmitting device comprising a power transmitting antenna unit that transmits the power transfer signal, a phase unit that adjusts a phase of the power transfer signal, a power transmitting-communication antenna unit that receives the intensity signal, and a power transmission control unit that has power transmission-side authentication information and controls the phase unit to perform phase control of the power transfer signal for the power receiving device for which authentication using the power reception-side authentication information and the power transmission-side authentication information has been successful.

This wireless power supply system performs phase control for a successfully authenticated power receiving device and transmits power to it. Therefore, compared to when this configuration is not adopted, it is possible to suppress power transmission to unauthenticated power receiving devices and thereby improve power transmission efficiency.

### Embodiment

### General configuration of a wireless power supply system 1

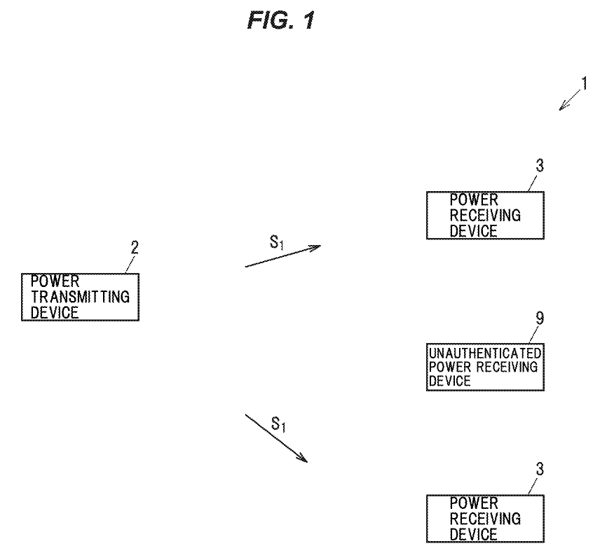

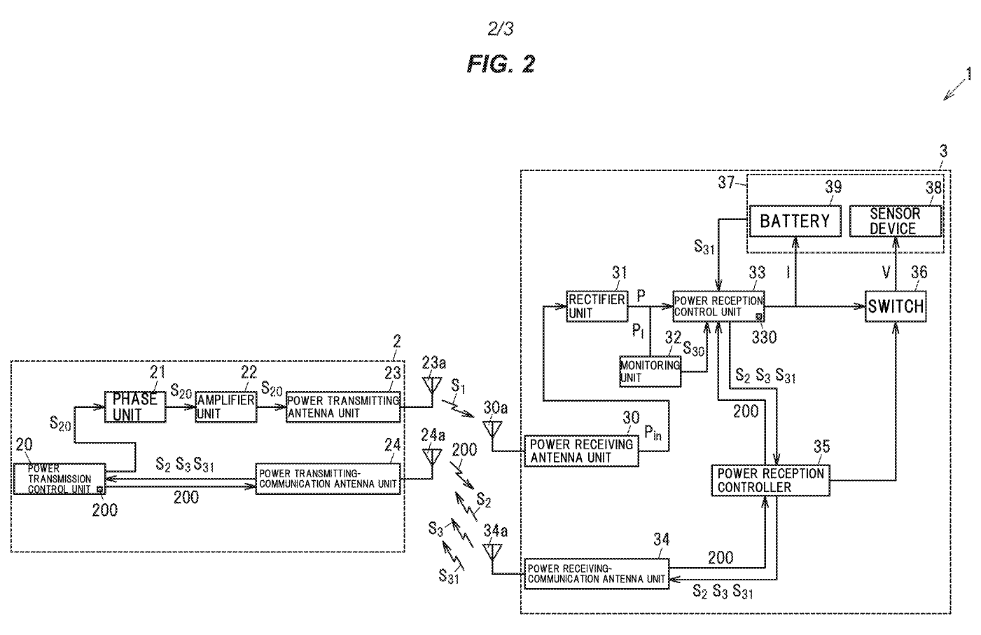

FIG. 1 is a diagram illustrating an example of a wireless power supply system in the embodiment. FIG. 2 is an example block diagram illustrating the wireless power supply system in the embodiment. In FIG. 2, flows of main signals and information are indicated by arrows. First, a general configuration of the wireless power supply system 1 will be described below.

As shown in FIG. 1, the wireless power supply system 1 is generally composed of a power transmitting device 2 and plural power receiving devices 3 successfully authenticated against the power transmitting device 2, as an example. FIG. 1 also shows an unauthenticated power receiving device 9 that fails authentication against the power transmitting device 2. The power transmitting device 2 is configured to perform power transmission with phase control for the successfully authenticated plural power receiving devices 3 and to not perform power transmission with phase control for the unauthenticated power receiving device 9.

In particular, as shown in FIG. 2, the wireless power supply system 1 is generally composed of the power receiving devices 3 each having a power receiving antenna unit 30 that receives a power transfer signal S₁, a rectifier unit 31 that rectifies the power transfer signal S₁ into received power P, a monitoring unit 32 that monitors an intensity P_{I} of the received power P, a power receiving-communication antenna unit 34 that transmits an intensity signal S₂ related to the intensity P_{I} of the received power P, and a power reception control unit 33 that has power reception-side authentication information 330 and controls the power receiving-communication antenna unit 34 based on a monitoring result of the monitoring unit 32 to transmit the intensity signal S₂; and the power transmitting device 2 having a power transmitting antenna unit 23 that transmits the power transfer signal S₁, a phase unit 21 that adjusts a phase of the power transfer signal S₁, a power transmitting-communication antenna unit 24 that receives the intensity signal S₂, and a power transmission control unit 20 that has power transmission-side authentication information 200 and controls the phase unit to perform phase control of the power transfer signal S₁ for the power receiving devices 3 for which authentication using the power reception-side authentication information 330 and the power transmission-side authentication information 200 has been successful, as an example.

The power transmitting device 2 performs optimization by repeatedly communicating with the successfully authenticated power receiving device 3 and transmits an optimal power transfer signal S₁ to the power receiving device 3.

The power transfer signal S₁ and the intensity signal S₂ preferably have different frequencies. The power transfer signal S₁has a frequency of 5.7 GHz as an example, but it is not limited thereto. The intensity signal S₂ has a frequency of 2.4 GHz as an example, but it is not limited thereto.

The power reception control unit 33 acquires device information S₃₁ related to electrically connected electronic devices 37 and transmits it through the power receiving-communication antenna unit 34. The power transmission control unit 20 performs phase control of the power transfer signal S₁ for the power receiving device 3, based on the device information S₃₁ received through the power transmitting-communication antenna unit 24.

The electronic devices 37 are a sensor device 38 and a battery 39 as an example, but are not limited thereto. The sensor device 38 outputs, e.g., information about measured values, such as measured temperature or humidity, etc., as the device information S₃₁. The battery 39 outputs, e.g., information about the remaining battery capacity, etc. as the device information S₃₁. The battery 39 is, e.g., a lead-acid battery, a nickel-metal hydride battery, a lithium-ion battery, and a sodium-sulfur battery, etc. For the power receiving device 3, e.g., plural batteries 39 may be included or the battery 39 may be removable.

The power transmitting device 2 transmits the power transmission-side authentication information 200 to the power receiving device 3 through the power transmitting-communication antenna unit 24. The power receiving device 3 performs authentication of the power reception-side authentication information 330 based on the power transmission-side authentication information 200 acquired from the power transmitting device 2, and when the authentication is successful, transmits an authentication success signal S₃ to the power transmitting device 2 through the power receiving-communication antenna unit 34.

In the wireless power supply system 1 of the present embodiment, authentication is performed on the power receiving device 3 side based on the power transmission-side authentication information 200 transmitted from the power transmitting device 2. However, it is not limited thereto, and authentication may also be performed on the power transmitting device 2 side based on the power reception-side authentication information 330 transmitted from the power receiving device 3.

### Configuration of the power transmitting device 2

As shown in FIG. 2, the power transmitting device 2 is generally composed of, e.g., the power transmission control unit 20, the phase unit 21, an amplifier unit 22, the power transmitting antenna unit 23, and the power transmitting-communication antenna unit 24. By performing phase control, the power transmitting device 2 transmits the power transfer signal S₁ optimal for the successfully authenticated power receiving device 3. The power transmission control unit 20, the phase unit 21 and the amplifier unit 22 are integrated into an IC (Integrated Circuit), as an example.

The power transmission control unit 20 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the power transmission control unit 20. The RAM is used as, e.g., a storage area to temporarily store calculation results, etc. The power transmission control unit 20 also has, inside thereof, a means to generate a clock signal and operates based on the clock signal.

The power transmission control unit 20 generates, e.g., a high-frequency power transmission signal S₂₀. For example, the phase unit 21 adjusts the phase of the power transmission signal S₂₀. For example, the amplifier unit 22 amplifies the power transmission signal S₂₀ and also removes unwanted frequency components such as noise from the power transmission signal S₂₀, and outputs the resulting signal to the power transmitting antenna unit 23.

The power transmitting antenna unit 23 transmits, e.g., the power transmission signal S₂₀ as the power transfer signal S₁. This power transmitting antenna unit 23 has a power transmitting antenna 23a which is a phased array antenna, as an example.

The power transmitting-communication antenna unit 24 has, e.g., a power transmitting-communication antenna 24a composed of microstrip antennas (planar antennas). The power transmitting-communication antenna unit 24 transmits the power transmission-side authentication information 200 and also receives the intensity signal S₂, the authentication success signal S₃, and the device information S₃₁.

Based on the received authentication success signal S₃, the power transmission control unit 20 determines the power receiving device 3 to which power is to be transmitted. Then, based on the intensity signal S₂ received from the successfully authenticated power receiving device 3, the power transmission control unit 20 performs beam steering to perform optimization of concentrating the power transfer signal S₁ so that the received power P is maximized.

Meanwhile, when there is no reception of the authentication success signal S₃ within a predetermined time after transmitting the power transmission-side authentication information 200 to the power receiving device 3, the power transmission control unit 20 determines that this power receiving device 3 has failed the authentication.

### Configuration of the power receiving device 3

The power receiving device 3 is generally composed of the power receiving antenna unit 30, the rectifier unit 31, the monitoring unit 32, the power reception control unit 33, the power receiving-communication antenna unit 34, a power reception controller 35, a switch 36, and the electronic devices 37. The rectifier unit 31, the monitoring unit 32 and the power reception control unit 33 are integrated into an IC, as an example.

The power receiving antenna unit 30 has, e.g., a power receiving antenna 30a composed of microstrip antennas. The power receiving antenna unit 30 receives the power transfer signal S₁ and outputs it to the rectifier unit 31 as AC input power Pᵢₙ.

The rectifier unit 31 converts the AC input power Pᵢₙ into the received power P, which is DC power, and outputs the received power P to the power reception control unit 33.

The monitoring unit 32 constantly monitors the intensity P_{I} of the received power P, and outputs monitoring information S₃₀, which is information about the intensity P_{I}, to the power reception control unit 33. The monitoring unit 32 is composed of, e.g., an RF (Radio Frequency) detector or a Schottky barrier diode, etc. The power consumption of the monitoring unit 32 is about several μA, as an example. The response speed of the monitoring unit 32 is several μs to several ns, as an example. This power consumption and response speed are superior to, e.g., a case where a beacon signal is constantly output to the power transmitting device 2 to perform phase control, etc.

The power reception control unit 33 is, e.g., a microcomputer composed of a CPU, a RAM, and a ROM, etc. The ROM stores, e.g., a program for operation of the power reception control unit 33. The RAM is used as, e.g., a storage area to temporarily store calculation results, etc. The power reception control unit 33 also has, inside thereof, a means to generate a clock signal and operates based on the clock signal.

The power reception control unit 33 includes a DC (Direct Current)-DC circuit or an MPPT (Maximum Power Point Tracking) control circuit, etc. that converts the received power P into a voltage suitable for driving the sensor device 38 or charging the battery 39, and generates and outputs a drive voltage V for driving the sensor device 38 and a charging current I for charging the battery 39 respectively to the sensor device 38 and the battery 39.

The power receiving-communication antenna unit 34 has, e.g., a power receiving-communication antenna 34a composed of microstrip antennas. The power receiving-communication antenna unit 34 of the power receiving device 3 receives the power transmission-side authentication information 200 and also transmits the intensity signal S₂, the authentication success signal S₃, and the device information S₃₁.

The power reception controller 35 controls the power receiving-communication antenna unit 34. The power reception controller 35 also controls the switch 36.

The switch 36 switches supply of the drive voltage V to the sensor device 38 between on and off under the control of the power reception controller 35.

The power reception control unit 33 has the power reception-side authentication information 330. The following authentication method is one example of the authentication method using the power reception-side authentication information 330 and the power transmission-side authentication information 200.

### Authentication method

The authentication method can be of various types, such as a pre-shared key (PSK) method, a challenge-response method, a one-time challenge method, a public key cryptography method, and a message authentication code method.

As an example, the authentication method in the present embodiment is the pre-shared key method in which a shared secret key stored in the power transmitting device 2 and the power receiving device 3 is compared, but the method is not limited thereto. The power transmission-side authentication information 200 is a secret key on the power transmitting device 2 side. The power reception-side authentication information 330 is a secret key on the power receiving device 3 side. The power receiving device 3 compares the secret key based on the acquired power transmission-side authentication information 200 with the secret key based on the power reception-side authentication information 330, and when they match, outputs the authentication success signal S₃ indicating successful authentication to the power transmitting device 2.

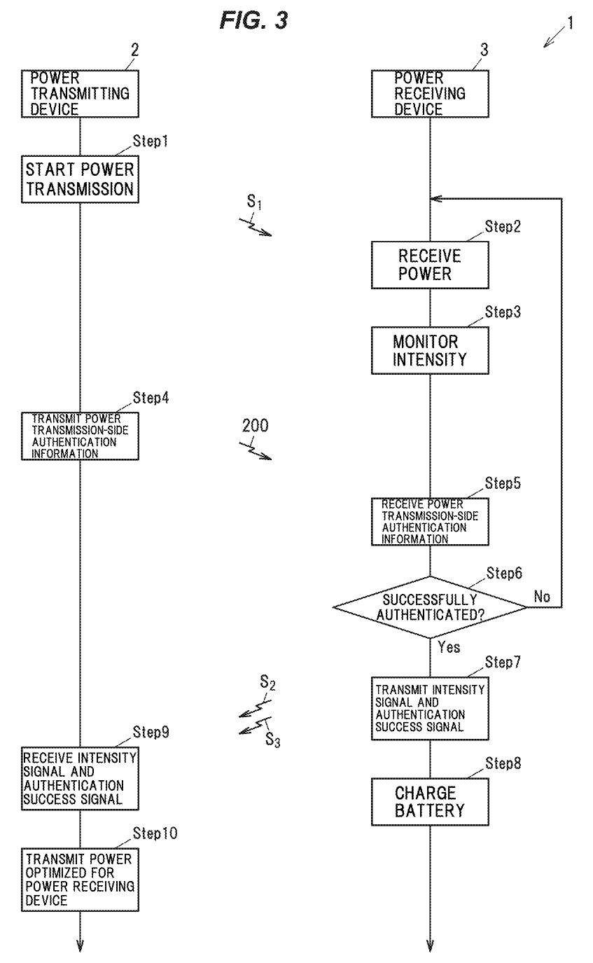

Next, an example operation of the wireless power supply system 1 in the present embodiment will be described with reference to the sequence diagram in FIG. 3.

### Operation

The power transmitting device 2 starts transmission of the power transfer signal S₁ (Step 1).

The power receiving device 3 receives the power transfer signal S₁ (Step 2).

The power receiving device 3 monitors the intensity P_{I} of the received power P based on the received power transfer signal S₁ (Step 3).

The power transmitting device 2 transmits the power transmission-side authentication information 200 to the power receiving device 3 (Step 4).

The power receiving device 3 receives the transmitted power transmission-side authentication information 200 (Step 5). The power receiving device 3 performs authentication using the received power transmission-side authentication information 200 and the stored power reception-side authentication information 330. When the authentication is successful (Step 6: Yes), the power receiving device 3 transmits the intensity signal S₂ and the authentication success signal S₃ (Step 7). Upon successful authentication, the power receiving device 3 also charges the battery 39 (Step 8). When the power receiving device 3 includes the sensor device 38, the power receiving device 3 supplies the drive voltage V to the sensor device 38 through the switch 36.

The power transmitting device 2 receives the intensity signal S₂ and the authentication success signal S ₃from the power receiving device 3 (Step 9).

The power transmitting device 2 transmits the power transfer signal S₁, which has been optimized based on the intensity signal S₂ and the authentication success signal S₃ received from the power receiving device 3, to the successfully authenticated power receiving device 3 (Step 10).

Here, when the authentication is not successful in Step 6 (step 6: No), the power receiving device 3 proceeds the process to Step 2. When there is no reception of the authentication success signal S₃ for a predetermined period of time after transmitting the power transmission-side authentication information 200, the power transmitting device 2 determines that the authentication has failed, and does not perform phase control for the power receiving device 3 for which the authentication failed.

The power receiving device 3 for which authentication fails, i.e., the unauthenticated power receiving device 9, may be placed on, e.g., a device or human body being an object to be protected that must be protected from the power transfer signal S₁. Since the authentication for the unauthenticated power receiving device 9 fails, the power transmitting device 2 does not perform beam focusing, and radio wave exposure of the object to be protected can be suppressed.

The wireless power supply system 1 repeats such communication between the power transmitting device 2 and the power receiving device 3 and transmits an optimized power transfer signal S₁ to the power receiving device 3.

### Effects of the embodiment

The wireless power supply system 1 in the present embodiment can improve power transmission efficiency. In particular, in the wireless power supply system 1, power is transmitted to the successfully authenticated power receiving device 3. Therefore, compared to when this configuration is not adopted, it is possible to suppress power transmission to the unauthenticated power receiving device 9 and thereby improve power transmission efficiency.

Since the wireless power supply system 1 controls the phase based on the intensity P_{I} of the received power P, the power transfer signal S₁ can be optimized at lower cost than when this configuration is not adopted.

The wireless power supply system 1 optimally controls power densities respectively received by the power receiving device 3 and the unauthenticated power receiving device 9. Therefore, it is possible to protect human body or to keep interference with other wireless devices down, as compared to when this configuration is not adopted.

In the wireless power supply system 1, the power transmitting antenna 23a of the power transmitting antenna unit 23 is a phased array antenna, which allows for beam focusing and construction of a highly efficient system with simple circuit design, as compared to when using other antennas.

The wireless power supply system 1 does not perform beam focusing onto the unauthenticated power receiving device 9. Therefore, the radio waves to which the human body is exposed can be limited to not greater than the acceptable level as compared to when this configuration is not adopted.

In the wireless power supply system 1, the monitoring unit 32 required to optimize the phase of the power transfer signal S₁ is composed of an RF detector or a Schottky barrier diode. Therefore, the response speed is faster and the power consumption can be suppressed, as compared to when this configuration is not adopted.

Although the embodiment of the invention has been described, the embodiment is merely an example and the invention according to claims is not to be limited thereto. This new embodiment may be implemented in various other forms, and various omissions, substitutions and changes, etc., can be made without departing from the gist of the invention. In addition, not all combinations of the features described in the embodiment are necessary to solve the problem of the invention. Further, this embodiment is included within the scope and gist of the invention and also within the invention described in the claims and the range of equivalency.

### Reference Signs List

1 WIRELESS POWER SUPPLY SYSTEM

2 POWER TRANSMITTING DEVICE

3 POWER RECEIVING DEVICE

9 UNAUTHENTICATED POWER RECEIVING DEVICE

20 POWER TRANSMISSION CONTROL UNIT

21 PHASE UNIT

22 AMPLIFIER UNIT

23 POWER TRANSMITTING ANTENNA UNIT

23a POWER TRANSMITTING ANTENNA

24 POWER TRANSMITTING-COMMUNICATION ANTENNA UNIT

24a POWER TRANSMITTING-COMMUNICATION ANTENNA

30 POWER RECEIVING ANTENNA UNIT

30a POWER RECEIVING ANTENNA

31 RECTIFIER UNIT

32 MONITORING UNIT

33 POWER RECEPTION CONTROL UNIT

34 POWER RECEIVING-COMMUNICATION ANTENNA UNIT

34a POWER RECEIVING-COMMUNICATION ANTENNA

35 POWER RECEPTION CONTROLLER

36 SWITCH

37 ELECTRONIC DEVICE

38 SENSOR DEVICE

39 BATTERY

200 POWER TRANSMISSION-SIDE AUTHENTICATION INFORMATION

330 POWER RECEPTION-SIDE AUTHENTICATION INFORMATION

I CHARGING CURRENT

P RECEIVED POWER

P_{I} INTENSITY

Pᵢₙ AC INPUT POWER

S₁ POWER TRANSFER SIGNAL

S₂ INTENSITY SIGNAL

S₂₀ POWER TRANSMISSION SIGNAL

S₃ AUTHENTICATION SUCCESS SIGNAL

S₃₀ MONITORING INFORMATION

S₃₁ DEVICE INFORMATION

V DRIVE VOLTAGE

1. A wireless power supply system, comprising:
a power receiving device comprising a power receiving antenna unit that receives a power transfer signal, a rectifier unit that rectifies the power transfer signal into received power, a monitoring unit that monitors an intensity of the received power, a power receiving-communication antenna unit that transmits an intensity signal related to the intensity of the received power, and a power reception control unit that has power reception-side authentication information and controls the power receiving-communication antenna unit based on a monitoring result of the monitoring unit to transmit the intensity signal; and
a power transmitting device comprising a power transmitting antenna unit that transmits the power transfer signal, a phase unit that adjusts a phase of the power transfer signal, a power transmitting-communication antenna unit that receives the intensity signal, and a power transmission control unit that has power transmission-side authentication information and controls the phase unit to perform phase control of the power transfer signal for the power receiving device for which authentication using the power reception-side authentication information and the power transmission-side authentication information has been successful.

2. The wireless power supply system according to claim 1, wherein the power reception control unit acquires device information related to an electrically connected electronic device and transmits the device information through the power receiving-communication antenna unit, and wherein the power transmission control unit performs the phase control of the power transfer signal for the power receiving device, based on the device information received through the power transmitting-communication antenna unit.

3. The wireless power supply system according to claim 1, wherein the power transmitting device transmits the power transmission-side authentication information to the power receiving device through the power transmitting-communication antenna unit, and wherein the power receiving device performs the authentication of the power reception-side authentication information based on the power transmission-side authentication information acquired from the power transmitting device, and when the authentication is successful, transmits an authentication success signal to the power transmitting device through the power receiving-communication antenna unit.
